(19) United States
(12) Patent Application Publication
(10) Pub. No.: US 2011/0000381 A1
(43) Pub. Date: Jan. 6, 2011

(54) PIE CRUST RETAINER

(76) Inventor: Dave Dehart, Prosper, TX (US)

Correspondence Address: JOHN B. LINDSAY, 11700 Preston Rd Ste 660-167, Dallas, TX, 75230, US

(21) Appl. No.: 12/778,668

(22) Filed: May 12, 2010

Related U.S. Application Data
(60) Provisional application No. 61/213,170, filed on May 12, 2009.

(51) Int. Cl. A23P 1/10

(52) U.S. Cl. 99/432

(57) ABSTRACT

A pie crust crust retainer for precooking a pie crust comprising a plurality of joined spokes. Each spoke is unitary and has a spoke base, a spoke arc, and a spoke sidewall section oriented in substantially a planar relationship. The spoke bases radially extend from a base region to the spoke arc section. The spoke arcs extends upwardly and outwardly from the base region and are joined to the spoke sidewalls. The device has an optional lifting surface.

### PRIORITY

The present invention claims priority to provisional application 61/213,170, which has a filing date of May 12, 2009.

### BACKGROUND

1. Field of the Invention

The present invention relates to cooking apparatus, more specifically to a device for use when precooking a pie crust.

2. Description of the Related Art

During the preparation of a pie, it is often necessary to precook the crust to a desired shape and rigidity. The crust is typically placed in a pie pan and precooked until the desired shape and rigidity are reached. The preparer usually desires the shape to conform to the pie pan. The desired rigidity after precooking varies with the specific pie being prepared, with relevant factors including the type and amount of pie filling that will be used. Typically, the person preparing the crust seeks to maintain the integrity and control the dimensions of the crust during this stage. Events such as uncontrolled shrinking, bubbling, cracking, curling, or rising up of the crust are undesirable. Because the precook time varies with the specific pie being prepared, the specific crust, the precooking temperature, and other factors, the desired crust condition is best achieved by visual monitoring the crust during precooking. Once the desired crust condition is reached, the crust should remain in that desired condition in order for the remaining foodstuff to added. If the integrity of the crust is disturbed, undesirable pies may result. For example, if the crust surface has cracks, it may become soggy. If the crust cracks, the pie filling may not remain contained within the crust throughout the cooking process.

The related art has not yet solved many of the problems in the precooking process for crusts. One attempted solution involves using pie weights, where the pie weights are placed atop a lining covering the pie crust. The pie weights can be rice, beans, other foodstuff, ceramic balls, steel beads, or other materials that are loosely arranged across the surface of the crust during the precooking. If foodstuff is used as the pie weight, undesirable waste is produced upon removal of the pie weight, as the foodstuff life span as pie weight is limited. Moreover, pie weights are deficient in that a large volume of material is necessary, consistently controlled weight distribution of the pie weights across the pie crust surface is difficult, crust integrity may be compromised in removing the pie weights, and handling of hot pie weights presents some difficulty. Additionally, a substantially portion of the pie crust is covered during the precooking process, limiting visual monitoring of the pie crust.

Other related art attempts to address the problems during the precooking process. U.S. Pat. No. 2,167,038 to Damon, comprising upper and lower corresponding pan forms, presents visual monitoring of the pie crust during precooking. U.S. Pat. No. 2,595,684 to Lyons and U.S. Pat. No. 3,453,948 to Murphy disclose wire structures that are complex and present sidewall edges which are orthogonal to the direction of travel of the devices when removed from the pie crust. Those edges increase the contact of the sidewall with the pie crust, thus risking the integrity of the pie crust upon their removal. U.S. Pat. No. 4,228,731 to Butler discloses a spoke structure with substantially “A” shaped flaps fastened to a circumferential band. Again, the structure is complex and presents sidewall edges which are orthogonal to the direction of travel of the device when removed from the crust, thus risking the integrity of the crust upon their removal. While the related art may achieve their respective purposes, the problems in the precooking process for pie crusts still remain. Thus it would be desirable for an apparatus which addresses the problems in the pie crust precooking process.

### SUMMARY

The present invention is directed to a pie crust retainer comprising a plurality of joined spokes, with the spokes being comprised of a spoke base, a spoke arc, and a spoke sidewall section configured in a substantially coplanar relationship. The spoke bases extend along the spokes' respective radial axes from a base region and are substantially oriented in a radial plane. The spoke arcs extend angularly upwardly from the base region and outwardly substantially along the radial axes toward the spoke sidewalls. The radial plane's angular orientation with the plane defined by the spoke base, the spoke arc, and the spoke sidewall are configured to minimize pie crust contact on disengagement of the device from the pie crust.

These and other features, aspects, and advantages of the invention will become better understood with reference to the following description, appended claims, and accompanying drawings.

### BRIEF DESCRIPTION OF THE DRAWINGS

FIG. 1 illustrates a top perspective view of an embodiment of the invention;

FIG. 2 illustrates a top perspective view of an alternative embodiment of the invention;

FIG. 3 illustrates a side perspective view of the embodiment illustrated in FIG. 1;

FIG. 4 illustrates a side view of a spoke according to FIG. 1;

FIG. 5 illustrates a front view of a spoke according to FIG. 1;

FIG. 6 illustrates a side view of tan alternative embodiment of the invention;

FIG. 7 illustrates a top perspective view of the embodiment illustrated in FIG. 6; and

FIG. 8 illustrates a side perspective view of the embodiment illustrated in FIG. 6.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

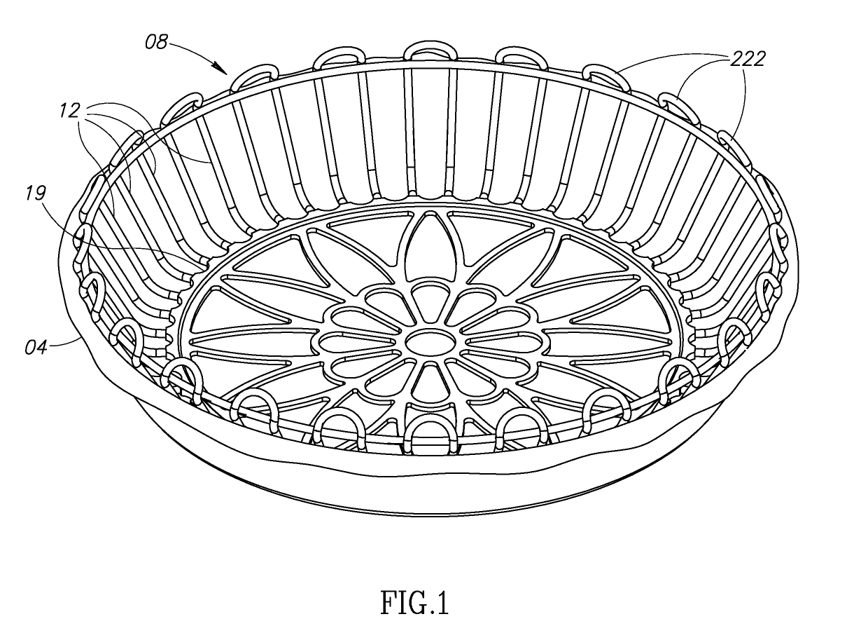

Referring to FIG. 1, an embodiment of a pie crust retainer 08 for retaining a pie crust 04 during the precooking process is illustrated. Although the term pie crust is used, the invention may be used in precooking any type of crust, such as tart crusts, pizza crusts, or pastry crusts. The pie crust retainer 08 includes a base region 10 and a sidewall region 20. As shown, the base region 10 is generally centrally located within the pie crust retainer 08 and presents a substantially planar surface where the bottom of a pie crust may be received.

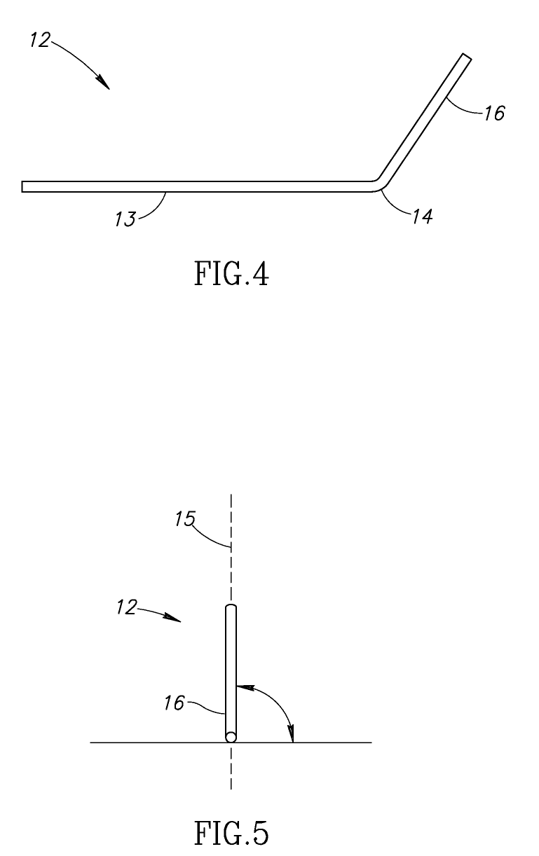

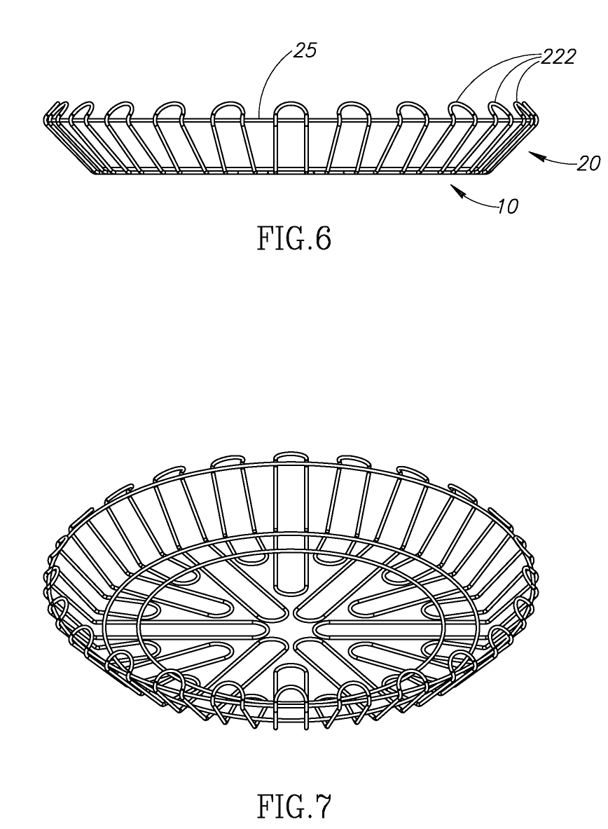

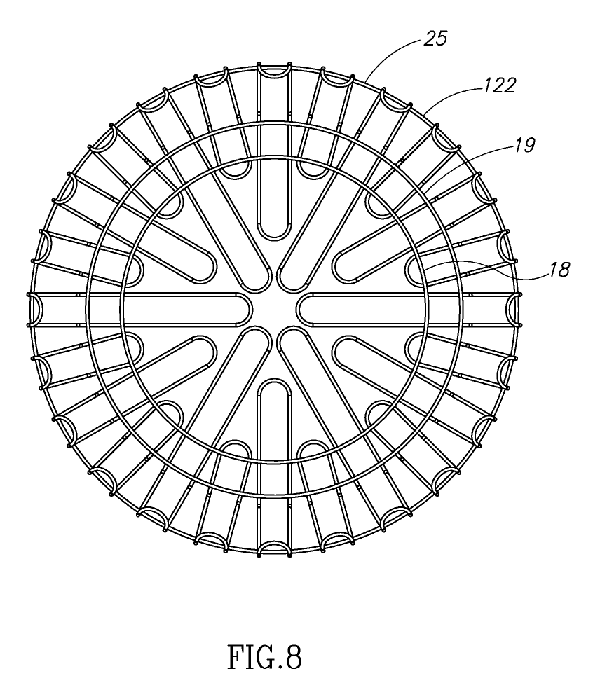

The pie crust retainer 08 of the current embodiment includes a plurality of spokes 12, base support 18, and a sidewall ring 25. As depicted in FIG. 4, the spoke 12 is a unitary member having a spoke base 13, spoke arc 14, and spoke sidewall 16 sections. The spoke 12 is preferably composed of steel, but may be composed of any rigid food-safe material capable of withstanding cooking temperatures, such as metals, plastics, ceramics, or glass. The spoke 12 has a spoke base 13 on one end which is secured to an arcuate portion 14 which in turn is secured to the spoke sidewall 16. The spoke 12 is dimensioned according to the corresponding pie pan 06, thus the spoke base 12 length, the degree of curvature of the spoke arc 14, and the spoke sidewall 16 dimensions may vary with the pie pan 06 and may span the base region 10 and the sidewall region 20.

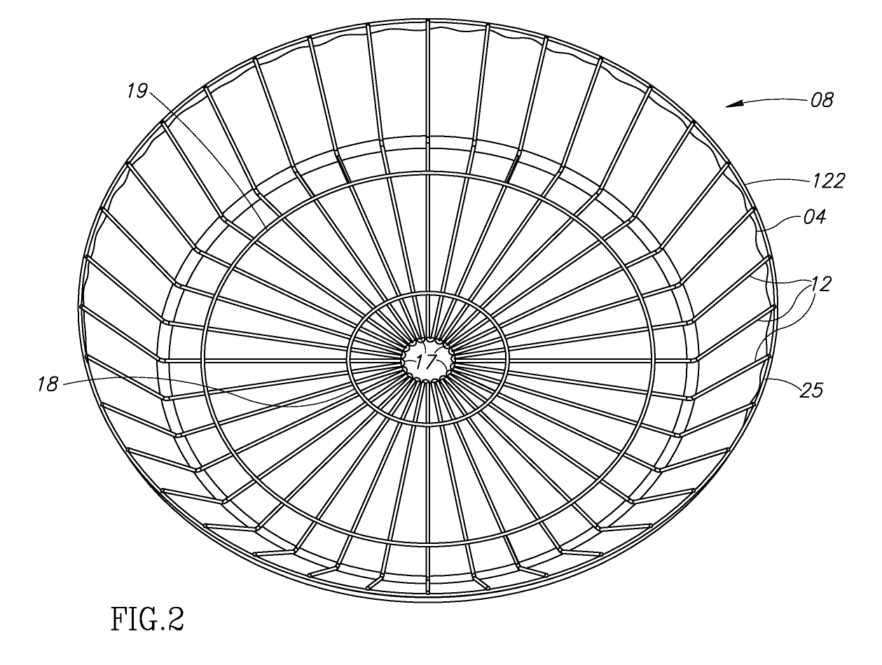

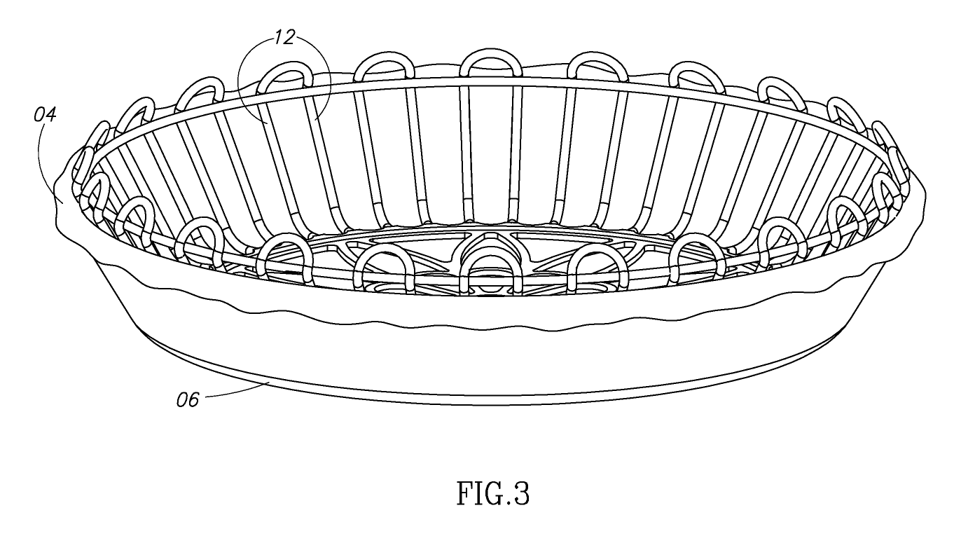

Referring to FIG. 2, a plurality of similarly dimensioned spokes 12 radially emanate from within the base region 10 where the spoke bases 13 form a substantially planar surface which presents a bottom surface for receipt of a pie crust 04. A perimeter of the base region is defined by the distal ends of the spoke bases 13, where the perimeter encompasses a portion of the radial plane. A base ring 19, which is depicted as a wire ring, may be located at or proximate the perimeter.

Extending from the distal end of each spoke bases 13 is a spoke arc 14. The spoke arc 14 is an arcuate section of the spoke 12 extending distally and upwardly from the center of the base region 10. On its other end, the spoke arc 14 is joined with a spoke sidewall 16. The spoke base 13, spoke arc 14, and spoke sidewall 16 sections of a given spoke 12 are generally coplanar.

FIG. 1 shows an alternative embodiment for the pie crust retainer 08. In the alternative embodiment, a base ring 19 is located proximate the perimeter of the base region 10. Rigid material is coupled to base ring 19 inside its periphery. In this embodiment, a plurality of spoke bases 13 are secured to the outer periphery of the base ring 19 and the spoke bases 13 then radially emanate from the base ring 19. Extending from the other ends of the spoke bases 13 are spoke arcs 14, extending distally and upwardly from the center of the base region 10. On its other end, the spoke arc 14 is joined with a spoke sidewall 16. The spoke base 13, spoke arc 14, and spoke sidewall 16 sections of a given spoke 12 are generally coplanar.

Each of the spokes 12 within the plurality may be mechanically fixed in relation to each other to maintain the overall structure of the pie crust retainer 08. The spokes 12 may be fixed by a base support 18 or a base ring 19. Additionally, the spokes 12 may be joined to other adjacent spokes 12 at their respective spoke base 13 ends via a hemispherical member 17 or other structures.

The plurality of spoke sidewalls 16 define the sidewall region 20. Referring to FIG. 5, each spoke 12, with its spoke base 13, spoke arc 14, and spoke sidewall 16 sections defines a plane 15. The angle of the intersection of that plane with the radial plane defined by the plurality of spoke bases 13 should be configured to minimize spoke sidewall 16 contact with the pie crust 04 when the pie crust retainer 08 is disengaged from the pie crust 04. A minimal section of the spoke sidewall 16 should contact the pie crust 04 during disengagement. Preferably the spoke's 12 plane is substantially orthogonal with the radial plane, however, the angle may range from about 45° to about 90°.

The pie crust retainer 08 may optionally include a lifting surface 22. The lifting surface 22 enables the pie crust retainer 08 to be disengaged from the pie crust 04. The lifting surface 22 may include an extension (not pictured) to the spoke sidewall 16 protruding inwardly toward the base region 10. Alternatively, the lifting surface may be a ring 122 secured to the perimeter of the sidewall region. Yet another lifting surface may be presented by a tab 222 formed by bridging proximate spoke sidewalls 16.

In order to use the pie crust retainer 08, a pie crust 04 is placed in the void presented by a pie pan 06. The pie crust retainer 08 is placed atop the pie crust 04. The pie crust 04 is precooked until it reaches the desired crust condition, visually monitoring the pie crust 04, as necessary. The pie crust retainer 08 is then disengaged from the pie crust 04 and the remaining foodstuff may be added.

Insofar as the description above and the accompanying drawing disclose any additional subject matter that is not within the scope of the single claim below, the inventions are not dedicated to the public and the right to file one or more applications to claim such additional inventions is reserved.

What is claimed is:

1. A pie crust retainer comprising:
a plurality of joined spokes, each of said spokes comprising a spoke base, a spoke arc, and a spoke sidewall section in a substantially coplanar relationship;
said spoke bases oriented substantially in a radial plane and extending along their respective radial axes in a base region;
said spoke arcs extending angularly upwardly from said base region and outwardly substantially along said radial axes to said spoke sidewalls; and
said radial plane's angular orientation with the plane defined by said spoke base, said spoke arc, and said spoke sidewall configured to minimize pie crust contact on disengagement.

2. The apparatus of claim 1 wherein said angular orientation is about 90°.

3. The apparatus of claim 1 wherein said angular orientation is between about 75° and about 90°.

4. The apparatus of claim 1 wherein said angular orientation is between about 60° and about 90°.

5. The apparatus of claim 1 wherein said angular orientation is between about 45° and about 90°.

6. The apparatus of claim 1 wherein said plurality of spokes is joined via a base support proximate said base region.

7. The apparatus of claim 1 wherein said plurality of spokes is joined via a base ring proximate said base region.

8. The apparatus of claim 1 wherein said plurality of spokes is joined via a sidewall ring proximate the sidewall region.

9. The apparatus of claim 1 further comprising a lifting surface.

10. The apparatus of claim 9 wherein said lifting surface comprises a sidewall ring.

11. The apparatus of claim 9 wherein said lifting surface comprises at least one tab formed from bridging proximate spoke sidewalls.

12. A pie crust retainer comprising:
a plurality of joined spokes, each of said spokes comprising a spoke base, a spoke arc, and a spoke sidewall section in a substantially coplanar relationship;
said spoke bases oriented substantially in a radial plane and extending along their respective radial axes from a base ring;
said spoke arcs extending angularly upwardly from said base region and outwardly substantially along said radial axes to said spoke sidewalls; and
said radial plane's angular orientation with the plane defined by said spoke base, said spoke arc, and said spoke sidewall configured to minimize pie crust contact on disengagement.

13. The apparatus of claim 12 wherein said angular orientation is about 90°.

14. The apparatus of claim 12 wherein said angular orientation is between about 75° and about 90°.

15. The apparatus of claim 12 wherein said angular orientation is between about 60° and about 90°.

16. The apparatus of claim 12 wherein said angular orientation is between about 45° and about 90°.

17. The apparatus of claim 12 wherein said plurality of spokes is joined via a base support proximate said base region.

18. The apparatus of claim 12 wherein said plurality of spokes is joined via a base ring proximate said base region.

19. The apparatus of claim 12 wherein said plurality of spokes is joined via a sidewall ring proximate the sidewall region.

20. The apparatus of claim 12 further comprising a lifting surface.

21. The apparatus of claim 20 wherein said lifting surface comprises a sidewall ring.

22. The apparatus of claim 20 wherein said lifting surface comprises at least one tab formed from bridging proximate spoke sidewalls.
